(19) United States
(12) Patent Application Publication
(10) Pub. No.: US 2004/0143626 A1
(43) Pub. Date: Jul. 22, 2004

(54) Method and system for operating a cache for multiple files

(75) Inventors: Bryan Kemp, Round Rock, TX (US); Gaston M. Barajas, Austin, TX (US); Steven Romohr, Austin, TX (US)

Correspondence Address: Roger Fulghum, Baker Botts L.L.P., 910 Louisiana, Houston, TX, 77002, US

(73) Assignee: DELL PRODUCTS L.P.

(21) Appl. No.: 10/348,643

(22) Filed: Jan. 21, 2003

(51) Int. Cl. G06F 15/16

(52) U.S. Cl. 709/203

(57) ABSTRACT

A method of operating a cache memory within an information handling system comprises the steps of defining a list of files to be requested from a storage system; searching the locations of each files within the storage system and determining the modification date/time of each file; searching the locations of each file within a cache memory and determining the modification date/time of each file; and determining whether the cache needs to be updated.

### FIELD OF THE INVENTION

The present invention relates to a computer system, in particular a server system including one or more independent sub-systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today's information handling systems, in particular server systems, comprise often a plurality of sub-systems. Many computer systems include centralized servers for providing centralized information to a plurality of sub-systems. For example, a build-to-order (BTO) system might comprise a centralized server storing a plurality of files which are necessary for the BTO process. Thus, at specific times these files are requested by a sub-system. In particular during high volume order times or peek times high volumes of file transfers will be initiated. Current file servers include cache systems which handle cache operations based on known principles, such as caching specific memory areas, a file or a buffer one at a time. If a plurality of files is requested, in particular, at different times, this can cause inefficiency of the cache mechanism and lead unwanted delays in the data transfer process.

### SUMMARY OF THE INVENTION

Therefore, a need for an improved method and system for managing a cache exists. A first embodiment of the present invention can be an information handling system comprising a centralized server system, a plurality of sub systems, a plurality of cache memories associated with each sub system, and a plurality of cache management units within each sub system for management of the associated cache memory wherein the cache memory caches a plurality of files from a requested list of files.

The list of files can be stored within an array comprising a plurality of file names and information indicating the last modification of any of the files within the list, wherein the information can be the modification date/time entry.

A method of operating a cache memory within an information handling system may comprise the steps of:

defining a list of files to be requested from a storage system;

searching the locations of each files within the storage system and determining the modification date/time of each file;

searching the locations of each file within a cache memory and determining the modification date/time of each file;

determining whether the cache needs to be updated.

Generally, a storage array and a cache array can be maintained in which the locations of the files are stored, respectively. A modification date/time for the list of files may be stored within each array. The step of determining whether an update is necessary can include the step of comparing the modification date/time of the array for the storage system with the respective modification date/time for the cache memory. The step of determining whether an update is necessary can include the step of comparing the modification date/time for each file of the array for the storage system with the respective modification date/time for the respective file in the cache memory array and deleting those files from the cache array which do not have an older modification date/time. The method may further comprise the step of deleting the files within the cache memory listed in the cache array and transferring the files listed in the cache array from the storage system into the cache. The method may further comprise the step of deleting the files within the cache memory listed in the cache array and transferring the files listed in the cache array from the storage system into the cache. If an update is necessary the method may further comprise the steps of determining the size of all files to be cached; determining the size of free space in the cache memory; and storing all files in the cache if enough memory is available. If the files from the list of files already exist within the cache memory, the method may comprise the step of deleting these files before the step of determining the size of free space within the cache memory. If the cache memory has not enough space the method may comprise the step of deleting the files with the oldest access date/time in the cache memory. The definition of a list of files can be achieved by identification through a portion of the filenames. The portion of the filenames can be the extension of a filename. Subsequent numbering within the extension can be used to define a list of files.

Other technical advantages of the present disclosure will be readily apparent to one skilled in the art from the following figures, descriptions, and claims. Various embodiments of the present application obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram of a system including a server and a plurality of sub-systems;

FIG. 2 is a principal flow chart of a cache management method according to the present invention; and

FIG. 3 is a detailed flow chart showing a method to manage the cache, for example, of a file server according to the embodiments of the present invention.

### DETAILED DESCRIPTION OF THE PREFERRED EMBODIMENTS

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

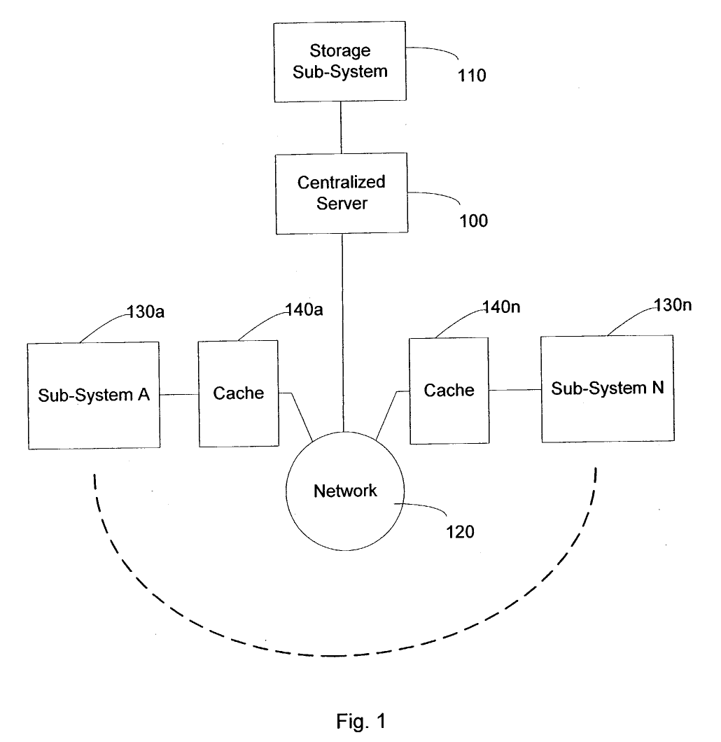

Turning to the drawings, exemplary embodiments of the present application will now be described. FIG. 1 shows a block diagram of a computer system using a centralized server. Such a system comprises a plurality of sub-systems 130a . . . 130n coupled through a network 120. Each sub-system 130a . . . 130n can be an independent computer system, such as a personal computer or a single server. A centralized server 100, such as a file server, is also coupled to the network. The centralized server 100 might further comprise additional storage sub-systems 110 couple with the server 100. According to the invention, a specific local cache 140a . . . 140n is provided for each sub-system to manage the in and out flow of multiple requested files from the centralized system.

For example, during a BTO-process, a sub-system 130a . . . 130n might request a plurality of files. The centralized file server 100 will retrieve those files, for example, from the storage sub-system 110 and transfer them to the respective sub-system 130a . . . 130n through network 120. In systems according to the prior art, the usually known cache management which is located within the centralized server 100 or storage sub-system 110 will apply during this transfer process. For example, a requested file or specific sections of such a file are transferred in and out of a cache as described above.

According to the present invention a different cache mechanism will be applied which greatly enhances the overall performance of the system. To this end, local cache memories 140a . . . 140n are used within each sub-system 130a . . . 130n. These cache memories 140a . . . 140n can be specifically designed memories within each system or dedicated memory space within the main memory of each computer subsystem 130a . . . 130n.

Generally, according to the present invention, this dedicated local cache memory 140a . . . 140n is managed to cache a plurality of files through a specific file list or table. Thus, instead of caching single files, memory blocks, etc. the system will cache a plurality of files by means of a list or table.

The file list or table usually contains a plurality of respective files. Of course other methods of defining a plurality of files can be used. For example, the extension of filenames can be used to generate a list within a directory. To this end, a first file is for example named xxxx.fi0, a second file xxxx.fi1, etc., wherein xxxx stands for any kind of filenames which can be even different within a directory. In another embodiment, if the file set is a set of zip files then the first file could be, for example, fileset.zip, the second one would be named fileset.z02 and so on. Any other appropriate portion of a filename can be used to identify a list of files through their filenames. Furthermore, any type of subsequent numbering through numbers letters or other characters can be implemented.

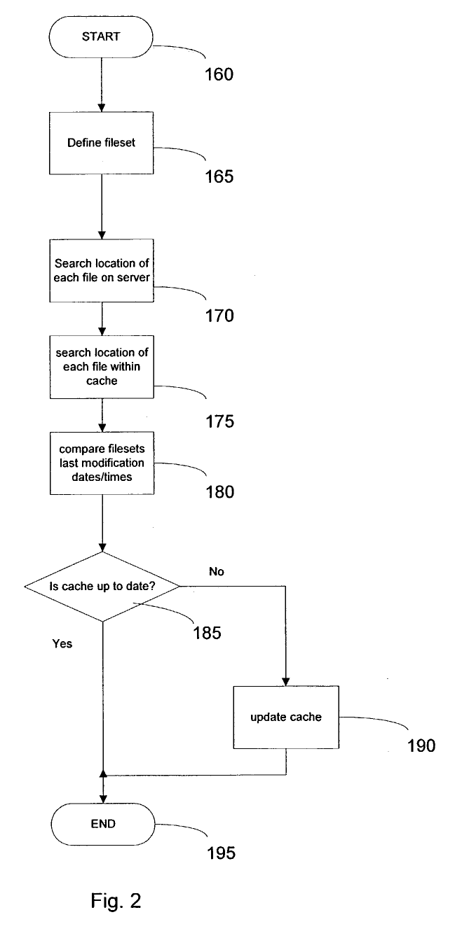

FIG. 2 shows a principal flow chart of cache mechanism according to the present invention. The routine starts in step 160. In step 165 a fileset is defined in form of a list or table. In step 170, the location of all files in this list is searched in the directory of the centralized server system 100/110. In step 175 the location of the same files are searched in the cache memory 140a . . . 140n of the respective sub system 130a . . . 130n. In step 180 the last modification dates/times of the files previously searched are compared. In step 185 it is then determined whether the cache is up to date. If the cache is up to date, then the routine stops in step 195. If the cache is not up to date, for example, one or more files have been modified since the files have been cached, a file has been added to the list which is not cached, or the cache does not contain any of the files yet then in step 190 the cache is updated. This update usually will comprise the step of deleting all files of the list as far as existent within the cache and transferring all files of the list from the centralized server to the cache.

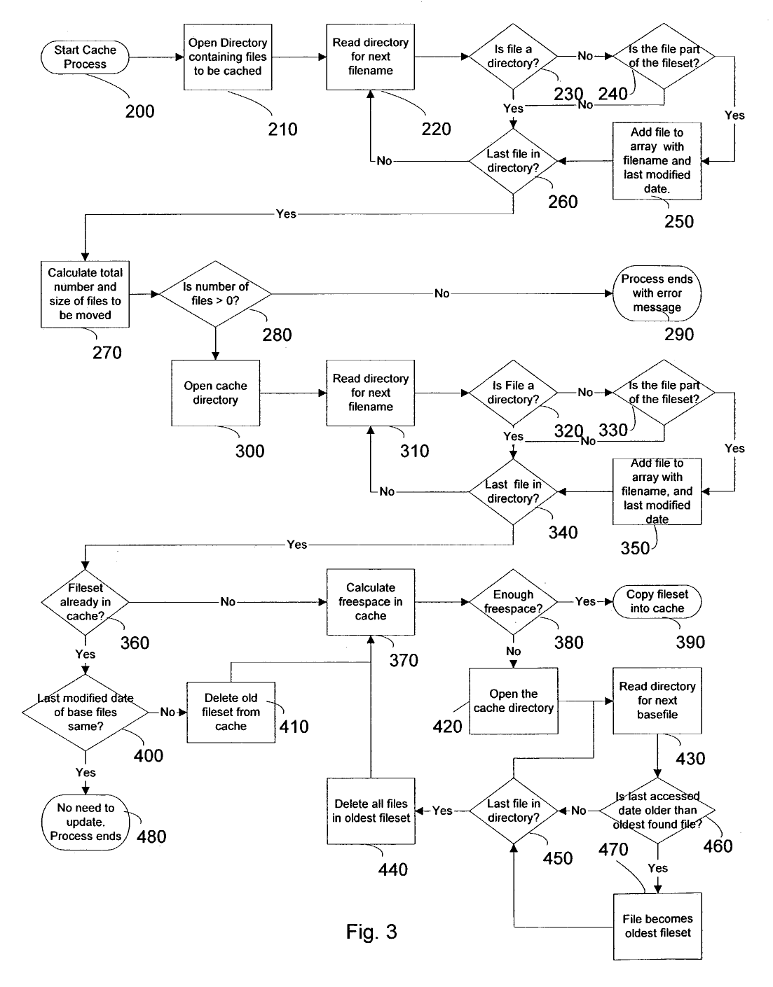

FIG. 3 shows the management of such a multiple file cache in more detail. The cache management starts in step 200. It is assumed that a list or table of files to be requested has been previously defined and stored respectively. In step 210 the directory containing the files to be cached is opened. In step 220, the first entry in form of a filename within this directory is read. In step 230, it is checked whether the respective entry is a file or another directory. If it is another directory, then in step 260 it is checked whether this is the last file in the directory. If not, then the routine continues with step 220. If in step 230 it is decided that the entry is a file then it is checked in step 240 whether the file is part of the respective fileset previously defined in a list or table. If yes, then this filename will be added to an array. Furthermore, the last modified date/time of the respective file can be stored in this array. However in another embodiment, the array might contain a plurality of entries for the filenames but only a single entry for the last modified date/time. This single entry is only overwritten if the respective modification date/time of the presently checked file is newer. Thus, when all files in the directory have been checked, the array will contain a single modification date/time which relates to the most recently modified file of the fileset. The routine then proceeds with step 260.

If in step 260 it is determined that the entry was the last entry in the directory, then the routine calculates the total number and size of the files to be moved/updated in step 270. If it is determined in step 280 that the number of files is 0, then the process ends with an error message in step 290. If the number of files is greater than 0 in step 280, then the cache directory in the cache 140a . . . 140n is opened in step 300.

Another array, for files stored in the cache, is determined similar as in steps 220-260. Thus, in step 310, the first entry in form of a filename within this cache directory is read. In step 320, it is checked whether the respective entry is a file or another directory. If it is another directory, then in step 340 it is checked whether this is the last file in the directory. If not, then the routine continues with step 310. If in step 320 it is decided that the entry is a file then it is checked in step 330 whether the file is part of the respective fileset previously defined in the list or table. If yes, then this filename will be added to the cache array. Furthermore, the last modified date/time of the respective file can be stored in this array. As described above with respect to another embodiment, the array might again contain a plurality of entries for the filenames but only a single entry for the last modified date/time. This single entry is again only overwritten if the respective modification date/time of the presently checked file is newer. Thus, when the all files in the cache directory have been checked, the cache array will contain a single modification date/time which relates to the most recently accessed or modified file of the fileset. The routine then proceeds with step 340.

If in step 340 it is determined that the entry was the last entry in the cache directory, then the routine checks in step 360 whether the fileset has been already previously been stored in the cache. For example, if the cache array is empty then none of the files has been stored previously. In this case, the routine proceeds with step 370 in which the free space within the cache is calculated. In step 380 it is determined whether there is enough space in the cache memory 140a . . . 140n by comparing the previously in step 270 calculated total size with the in step 370 determined free space. If there is enough space, then the fileset will be copied into the respective cache memory 140a . . . 140n in step 390. If there is not enough space, then the cache directory is opened in step 420. In step 430 the next base file is read and in step 460 it is determined whether this file has the oldest access date/time within the directory. If yes, then in step 470 the filename is stored in a specific oldest file array. The routine then proceeds with step 450. If the file does not have the oldest access date/time, then the routine proceeds to step 450 in which it is determined whether this file is the last file in the cache directory. If no, then the routine proceeds with step 430. If yes, then the routine deletes all files listed in the oldest file array from the cache in step 440 and proceeds with step 370.

If in step 360 it is determined that the fileset is already present within the cache, it is determined in step 400 whether an update of the cache is necessary or not. For example, in the first embodiment each filename has an associated entry for the last modification dates/times. Thus, the modification dates/times of all files of the first array and the cache array can be compared and the files which are up to date can be deleted from the respective array. Then, the routine proceeds with step 410 in which the remaining files as listed in the respective array are deleted from the cache and the routine continues with step 370.

In the second embodiment, only a single modification date/time is stored in both arrays. Thus, only these date/time entry has to be compared to determine whether the cache is up to date. If the cache is not up to date, then the old fileset stored in the cache is deleted in step 410 and the routine proceeds with step 370.

If in step 400 it is determined that no update is necessary, then the routine ends in step 480. The embodiments described above use the modification date/time stamp which is handled by the operating system to determine whether a file has been recently modified. However, if an operating system uses only an access date/time entry then this entry can be used instead of the modification date/time entry. Any other information suitable to determine the last modification of a file can be used. Similarly, the access date/time entry is used to determine the file/s which are the files with the oldest access date/time stamp for purposes of freeing space in the cache. Again, any other suitable information depending on the operating system can be used for this purpose.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. Information handling system comprising:
a centralized server system;
a plurality of sub systems;
a plurality of cache memories associated with each sub system; and
a plurality of cache management units within each sub system for management of the associated cache memory wherein the cache memory caches a plurality of files from a requested list of files.

2. Information handling system according to claim 1, wherein the list of files is stored within an array comprising a plurality of file names and information indicating the last modification of any of the files within the list.

3. Information handling system according to claim 2, wherein the information is the modification date/time entry.

4. Method of operating a cache memory within an information handling system comprising the steps of:
defining a list of files to be requested from a storage system;
searching the locations of each files within the storage system and determining the modification date/time of each file;
searching the locations of each file within a cache memory and determining the modification date/time of each file; and
determining whether the cache needs to be updated.

5. Method according to claim 4, wherein a storage array and a cache array is maintained in which the modification date/time is stored separately with the location of each file, respectively.

6. Method according to claim 4, wherein a storage array and a cache array is maintained in which the locations of the files are stored, respectively.

7. Method according to claim 6, wherein a modification date/time for the list of files is stored within the array.

8. Method according to claim 6, wherein the step of determining whether an update is necessary includes the step of comparing the modification date/time of the array for the storage system with the respective modification date/time for the cache memory.

9. Method according to claim 5, wherein the step of determining whether an update is necessary includes the step of comparing the modification date/time for each file of the array for the storage system with the respective modification date/time for the respective file in the cache memory array and deleting those files from the cache array which do not have an older modification date/time.

10. Method according to claim 9, further comprising the step of deleting the files within the cache memory listed in the cache array and transferring the files listed in the cache array from the storage system into the cache.

11. Method according to claim 5, further comprising the step of deleting the files within the cache memory listed in the cache array and transferring the files listed in the cache array from the storage system into the cache.

12. Method according to claim 5, if an update is necessary further comprising the steps of:
determining the size of all files to be cached;
determining the size of free space in the cache memory;
storing all files in the cache if enough memory is available.

13. Method as in claim 12, wherein if the files from the list of files already exist within the cache memory, deleting these files before the step of determining the size of free space within the cache memory.

14. Method as in claim 12, wherein if the cache memory has not enough space deleting the files with the oldest access date/time in the cache memory.

15. Method as in claim 4, wherein the definition of a list of files is achieved by identification through a portion of the filenames.

16. Method as in claim 15, wherein the portion of the filenames is the extension of a filename.

17. Method as in claim 16, wherein subsequent numbering within the extension is used to define a list of files.
